(19) United States
(12) Patent Application Publication
(10) Pub. No.: US 2007/0107964 A1
(43) Pub. Date: May 17, 2007

(54) Motor vehicle provided with a stiffener strut

(76) Inventors: Winfried Bunsmann, Bissendorf (DE); Peter Kalinke, Osnabruck (DE)

Correspondence Address: FRIEDRICH KUEFFNER, 317 MADISON AVENUE, SUITE 910, NEW YORK, NY, 10017, US

(21) Appl. No.: 10/575,280

(22) PCT Filed: Oct. 6, 2004
(86) PCT No.: PCT/DE04/02213

§ 371 Date: Dec. 8, 2006

(30) Foreign Application Priority Data
Nov. 10, 2003 (DE) 103 47 365.3

(51) Int. Cl. B60K 25/10; B60K 37/00

(52) U.S. Cl. 180/165; 180/311; 296/203.01

(57) ABSTRACT

The invention relates to a vehicle, in particular a cabriolet car whose body comprises a least one strut (4, 5, 7, 8) provided with an element (4c, 5c, 7c, 8c) which is longitudinally movable with respect to the body by repetitive longitudinal stresses opposite to the vehicle driving direction. According to said invention, the vehicle is constructed in such a way that the element (4c, 5c, 7c, 8c) is displaceable with respect to an energy converter (10, 10a, 10b, 10c, 11), thereby making it possible to brake the relative motion of the strut (4, 5, 7, 8) with respect to the body and to convert the strut (4, 5, 7, 8) motional energy into a least one other form of energy.

The invention concerns a motor vehicle, especially a convertible, in accordance with the introductory clause of Claim 1, and a motor vehicle with a frame in accordance with the introductory clause of Claim 12.

A general problem encountered with motor vehicles is that external excitation of body motions during driving, say, by driving over uneven roadway features, for example, potholes or bumps, can cause undesired vibrations of the automobile body. Vibrations of this sort in the automobile body reduce driving safety and comfort. This problem is especially pronounced in convertibles with an integral body and frame, which, due to the nonrigid roof that cannot brace the body, especially when the roof is open, have a stability disadvantage compared to closed vehicle superstructures. However, this is basically a problem in all vehicles, including those that do not have an integral body and frame, say, frame vehicles, such as motorcycles or vehicles with an aluminum body, which are wholly or partially supported by a sectional frame.

It is well known that so-called vibration dampers, i.e., damping masses, can be provided to prevent the development of vibrations, which are suitable for damping vibrations of certain frequencies, to which the dampers are tuned. The tuning is possible only for a certain individual frequency. Moreover, adaptation to the given vehicle type is necessary, and the arrangement of the dampers in the hollow spaces of the car body is structurally difficult. The dampers themselves must have a high mass, which is at odds with the low vehicle weight and economical operation that are desired.

DE 198 20 617 C2 reveals the possibility of equipping individual, inherently length-variable struts of an integral body and frame or of a vehicle frame with a detection unit for detecting external longitudinal stresses on the given strut, a actuator for producing an active counterforce, and a control unit for the actuator. This makes it possible selectively to counteract the external excitation of vibration with short response times. However, this requires considerable structural expense, since control units and actuators must be provided for each strut, and power must be supplied for their use.

The objective of the invention is to simplify the moderation of external excitation of vibration in a motor vehicle of the specified type.

The invention achieves this objective with a motor vehicle with the features of Claim 1 and with a motor vehicle with the features of Claim 12, which can be realized individually or in combination with one another. Advantageous refinements of the object of the invention are specified in dependent Claims 2 to 11.

For a vehicle with a wholly or partially integrated body and frame and/or for a vehicle with a supporting frame, the design of the invention in accordance with Claim 1 or Claim 12 makes it possible to achieve a reduction of vibrations by purely passive inhibition of the extension or compression of struts, i.e., elongated structures of the body or frame, by damping without the necessity of supplying actuators or detection units on these struts with their own power supply. Components of this type are completely unnecessary, and this further simplifies construction and installation. In this regard, the greatest possible passive damping of motion is advantageous in order to increase resistance to the development of vibrations. For this purpose, a distance of movement of the strut part or of the strut can be several millimeters under suitable stress.

If an energy storage device is provided, the energy obtained from the motion of the body strut(s) can be temporarily stored and used for other purposes.

If the strut(s) are designed as bracing components that are separate from the actual body, for example, an integral body and frame, the struts can be installed together with the respective energy converter as a prefabricated module below the underbody of the vehicle. In addition, beyond the respective vibration damping, each strut can thus also perform the function of a bracing component in a vehicle with, for example, an integral body and frame. The struts can also be part of a supporting frame. In vehicles with several bracing struts, some of them can be connected in accordance with the invention, while others can be permanently connected at both ends in the conventional way—with minimal damping of less than one percent—or can be designed with active counterforce action by actuators, likewise with minimal damping.

A damping energy converter can be created, for example, if the moving part of the strut is immersed in fluid in the manner of a piston and moves it when the strut experiences longitudinal stress. Advantageously, the fluid can then be conveyed by a propeller and generate electric power by its rotation.

Wear-free relative motion of the moving part of the strut is possible if the moving part is immersed without contact in a magnetic field of a coil arrangement. Voltages can then be induced by the motion of the strut and utilized.

Further advantages and features of the invention are described below with reference to the specific embodiment of the object of the invention that is illustrated in the drawings.

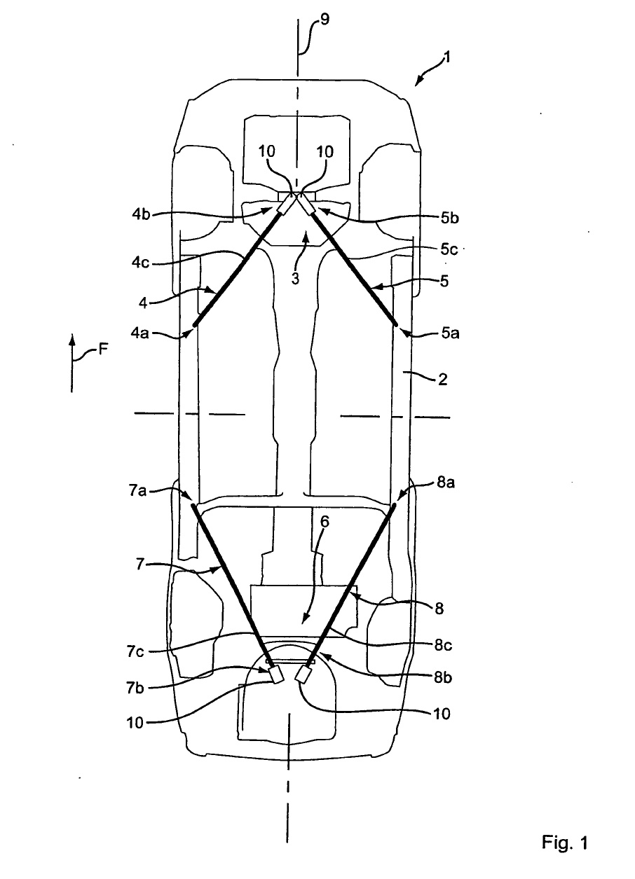

FIG. 1 shows a schematic view of the underbody of a motor vehicle from below with bracing struts that extend essentially diagonally.

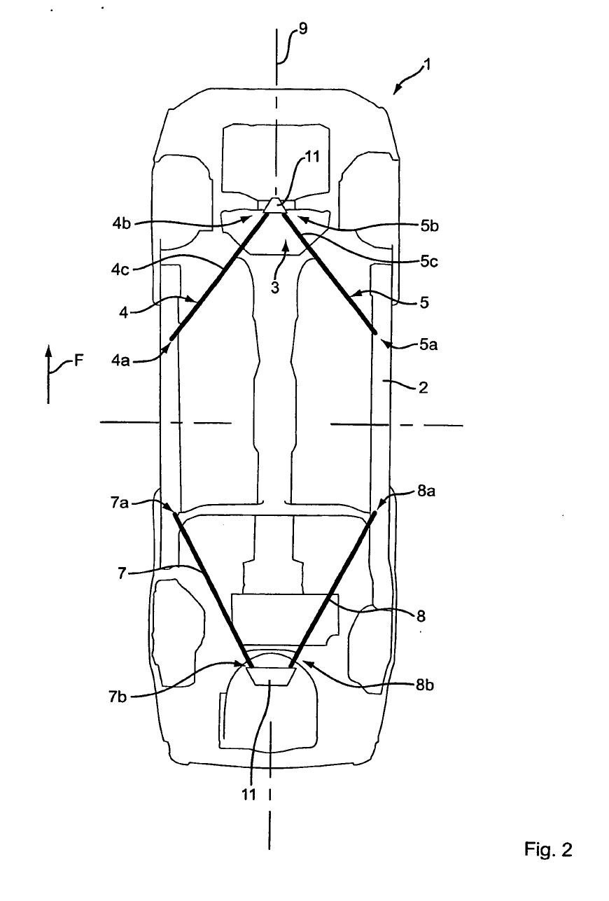

FIG. 2 shows a view similar to that of FIG. 1 with two struts at each end of the vehicle entering a common energy converter.

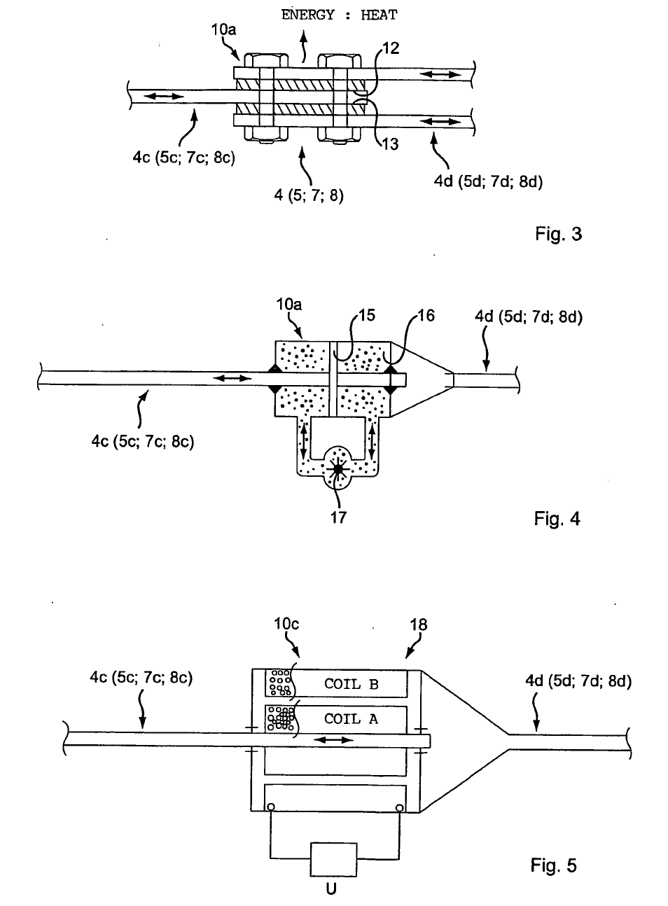

FIG. 3 shows a detail view of a moving strut part that is in frictionally engaged contact with a mechanical energy converter.

FIG. 4 shows a detail view of a moving strut part that engages in the manner of a piston in an energy converter that contains a fluid.

FIG. 5 shows a detail view of a moving strut part that engages without contact an energy converter that contains a coil arrangement.

According to the specific embodiment illustrated in FIG. 1, a front pair 3 of bracing struts 4, 5 and a rear pair 6 of bracing struts 7, 8 are assigned to the underbody 2 of a motor vehicle 1. Each strut runs essentially diagonally. This number and this arrangement of struts is not required and is shown only as an example.

The pairs 3, 6 are each arranged approximately symmetrically to a vertical longitudinal center plane 9. Their struts 4, 5 and 7, 8, respectively, extend from the outer peripheral areas of the underbody 2 to a point close to the vertical longitudinal center plane 9. They are each designed here as sections that are separate from the underbody 2, e.g., as tubular sections or box sections, which are made of metal or perhaps of a fiber-reinforced plastic. The form of the struts 4, 5, 7, 8 can differ considerably from the linear form shown here, e.g., angled components and/or components that are flat in some regions are also possible.

At their ends 4a, 5a, 7a, 8a that point outward in the transverse direction, the struts 4, 5, 7, 8 are connected with the underbody 2. For this purpose, the ends can be formed as flattened flange regions, each of which has a hole through which fastening means can be passed. It is also possible to weld the struts 4, 5, 7, 8 to the automobile body or to attach them in some other way.

The end regions 4b, 5b, 7b, 8b of the struts at the opposite end from the body connection of the struts 4, 5 of the pair of struts 3 and the struts 7, 8 of the pair of struts 6 are held in and can be moved relative to an energy converter 10, 11. The energy converter 10, 11 itself is movably held on the vehicle body. In the embodiment shown in FIG. 1, exactly one energy converter 10, 10a, 10b, 10c is assigned as a mounting device to each strut 4, 5, 7, 8. In the embodiment shown in FIG. 2, two struts 4, 5 of a pair 3 or two struts 7, 8 of a pair 6 always enter a common motion-damping energy converter 11.

In this regard, an energy converter 10, 10a, 10b, 10c, 11 is a device in which a moving part of the strut 4, 5, 7, 8, which in this case is formed by the entire strut, is braked in its motion, and its kinetic energy is at least partially converted to another form of energy. This produces the greatest possible damping of the motion of each strut 4, 5, 7, 8 without the need for an active component. Compared to a fixed mounting of both ends of a continuous strut, the damping should at least double. Therefore, here each strut 4, 5, 7, 8 has an end 4a, 5a, 7a, 8a that is secured to the automobile body and a free end 4b, 5b, 7b, 8b that is braked in the energy converter 10, 10a, 10b, 10c or 11 and is thus movably supported to allow motion damping. The struts 4, 5, 7, 8 could also each be divided, for example, in the middle, and would then comprise a moving part 4c, 5c, 7c, 8c and a part 4d, 5d, 7d, 8d that is secured to the automobile body, in which case the given energy converter 10, 10a, 10b, 10c would then be assigned to the part of the strut that is secured to the automobile body, as indicated in FIGS. 3 to 5.

An external excitation of a vibration, caused, for example, by the vehicle's riding over a pothole or a bump, by which torsion is produced in the automobile body, is passively counteracted by the action of the given energy converter(s) 10, 10a, 10b, 10c, 11 as vibration dampers.

In the specific embodiment shown in FIG. 3, the energy converter 10a is mechanically constructed and comprises two brake surfaces 12, 13, which are frictionally connected with the moving strut part 4c, 5c, 7c, 8c. Their contact tension on the moving strut part 4c, 5c, 7c, 8c can be manually or automatically readjusted, e.g., supported by spring force.

When, for example, one side of the vehicle passes over an unevenness in the roadway, a tensile force acts on the strut 4, 5, 7, 8 in the direction of the arrow 14, and this causes the strut to try to move in this direction relative to the surfaces 12, 13. However, due to the frictional engagement, extension of the strut is inhibited, and this results in damping. The external excitation is thus counteracted. Since the braking action starts immediately, very short response times are obtained, so that excitation frequencies of a few Hz to a few 10's of Hz can be effectively counteracted. The kinetic energy is converted mainly to thermal energy.

The energy converter 10b shown in FIG. 4 basically performs the same braking and damping function for the longitudinal motion of a moving strut part 4c, 5c, 7c, 8c. Here the damping is achieved by virtue of the fact that the moving strut part 4c, 5c, 7c, 8c is designed as a piston 15 at its end that faces the energy converter. The piston 15 is immersed in a pressure medium reservoir 16 that contains a high-viscosity fluid. The fluid can either be located in a closed pressure reservoir or is conveyed by motion of the piston 15 over an impeller 17 and drives it. The resistance of the impeller 17 to rotation can be adjustable. A generator can convert the rotational motion of the impeller 17 to electric power, which can be used elsewhere.

The energy converter 10c shown in FIG. 5 basically performs the same braking and damping function for the longitudinal motion of a moving strut part 4c, 5c, 7c, 8c. In this case, damping occurs without contact in the manner of an eddy-current brake, so that wear is minimized. In this regard, the moving strut part 4c, 5c, 7c, 8c penetrates a coil arrangement 18 and induces a countervoltage U in accordance with Lenz's law, so that the magnetic field that develops brakes the motion. The induced voltage U can be tapped and utilized as potential for doing work.

In another embodiment (not shown), the vehicle of the invention forms a tube frame, which serves as a supporting framework for the automobile body, which then does not have to be an integral body and frame. In this case, struts of this frame can likewise be designed in accordance with the invention, so that in this case the frame is not rigid but rather, as explained below, can actively respond to external excitation of vibrations. The invention can likewise be applied to a supporting frame, e.g., of a motorcycle.

It is also possible to use several different energy converters 10, 10a, 10b, 10c, 11 on struts 4, 5, 7, 8 of the same vehicle 1 and to combine them according to available space and other parameters.

It is also possible, besides the passive energy converters described here, to use active vibration dampers on other struts in such a way that a detection unit for the longitudinal motion of a strut and an actuator for counteracting this longitudinal movement are assigned to each strut 4, 5, 7, 8. In contrast to an active opposing effect of this type, which is not based on damping but rather on an actively applied opposing force, in the design in accordance with the invention, the energy converters 10, 10a, 10b, 10c, 11 provide purely passive damping that is as great as possible.

1. Motor vehicle (1), especially a convertible, with an automobile body, to which is assigned at least one strut (4, 5; 7, 8), which has a part (4c; 5c; 7c; 8c) that can move longitudinally relative to the body as a result of longitudinal stress produced during the operation of the vehicle, wherein the longitudinally moving part (4c; 5c; 7c; 8c) can move relative to an energy converter (10; 10a; 10b; 10c; 11) that acts as a damper for passive inhibition of extension or compression of the strut, and that the motion of the strut part (4c; 5c; 7c; 8c) relative to the body can be braked and the kinetic energy of the strut (4; 5; 7; 8) can be at least partially converted to another form of energy by the energy converter (10; 10a; 10b; 10c; 11).

2. Motor vehicle in accordance with claim 1, wherein an energy storage device for energy produced by conversion of the kinetic energy of the strut (4; 5; 7; 8) is assigned to the energy converter (10; 10a; 10b; 10c; 11).

3. Motor vehicle in accordance with claim 1, wherein an energy converter (10a) has at least one contact brake surface (12; 13) that frictionally engages the moving part (4c; 5c; 7c; 8c) of the strut (4; 5; 7; 8).

4. Motor vehicle in accordance with claim 1, wherein an energy converter (10b) has at least one pressure medium reservoir (16) that can be compressed by the moving part (4c; 5c; 7c; 8c) of the strut (4; 5; 7; 8).

5. Motor vehicle in accordance with claim 1, wherein an energy converter (10b) has a fluid that can be moved by the moving part (4c; 5c; 7c; 8c) of the strut.

6. Motor vehicle in accordance with claim 1, wherein an energy converter (10c) has a coil arrangement (18) that can be penetrated by the moving part of the strut.

7. Motor vehicle in accordance with claim 5, wherein the energy storage device comprises a storage battery.

8. Motor vehicle in accordance with claim 1, wherein the moving part (4c; 5c; 7c; 8c) of the strut (4; 5; 7; 8) constitutes at least almost the entire strut.

9. Motor vehicle in accordance with claim 1, wherein the strut (4; 5; 7; 8) has a multipart construction and comprises parts (4c, 5c, 7c, 8c; 4d, 5d, 7d, 8d) that can move relative to each other.

10. Motor vehicle in accordance with claim 9, wherein the movement of the parts (4c, 5c, 7c, 8c; 4d, 5d, 7d, 8d) relative to each other under suitable stress can be more than a millimeter.

11. Motor vehicle in accordance with claim 1, wherein at least two struts (4, 5 or 7, 8) are connected with each other by a common energy converter (11).

12. Motor vehicle (1), especially a convertible, with a supporting frame, which comprises at least one strut (4, 5; 7, 8), which has a part (4c; 5c; 7c; 8c) that can move longitudinally relative to other struts of the supporting frame as a result of longitudinal stress produced during the operation of the vehicle, wherein the longitudinally moving part (4c; 5c; 7c; 8c) can move relative to an energy converter (10; 10a; 10b; 10c; 11) that acts as a damper, by which the motion of the strut (4; 5; 7; 8) relative to the supporting frame can be braked, and the kinetic energy of the strut (4; 5; 7; 8) can be at least partially converted to another form of energy.
